(19) United States
(12) Patent Application Publication
(10) Pub. No.: US 2008/0177580 A1
(43) Pub. Date: Jul. 24, 2008

(54) Method for providing insurance protection against the loss of group health insurance coverage in the event of a disability of a plan participant

(76) Inventor: Mark J. Gabriel, Humble, TX (US)

Correspondence Address: Mark G. Gabriel, 12239 Fall River Pass Lane, Humble, TX, 77345, US

(21) Appl. No.: 11/654,988

(22) Filed: Jan. 18, 2007

(51) Int. Cl. G06Q 40/00

(52) U.S. Cl. 705/4

(57) ABSTRACT

A method for providing insurance protection against the inability to pay for, and consequential loss of, group health insurance benefits if an individual employee who is an active participant in the employer's group health plan becomes disabled. The invention provides for a disability insurance policy, or alternatively a combination of a plurality of disability insurance policies, that will pay both the employer and participant's portions of health insurance premiums during the period of COBRA coverage, with the monthly benefit amount determined by determining the total premium due under COBRA guidelines for the participant's group health insurance.

### RELATED APPLICATIONS

None

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a method for providing insurance protection in group health insurance plans against loss of health insurance coverage to a participant under COBRA provisions due to a disability that prevents the participant from performing the material and substantial duties of his occupation, by providing one disability insurance contract or a plurality of separate disability insurance contracts. In a preferred embodiment, the method uses (i) a portable short term disability insurance contract (hereinafter referred to as a policy) with a ninety (90) to one-hundred-and-eighty (180) day elimination period and a one-hundred-eighty (180) to three hundred and sixty-five (365) day benefit period, coupled with (ii) an individual disability insurance contract with a one-hundred and eighty (180) to three hundred and sixty-five (365) day elimination period and twenty-four (24) month benefit period.

2. Background and Description of Related Art

In 1986, Congress enacted the “Consolidated Omnibus Budget Reconciliation Act of 1985”, which has become known as COBRA. COBRA gives certain workers and their families the right to keep their group health insurance for a specified period of time after they leave their employer's plan. The law applies to most individuals who have participated in employer sponsored group benefit programs, and attempts to provide some measure of protection for workers and their families who have lost their insurance because of changes in their work or family life, such as losing a job or getting divorced. COBRA contains provisions that enable individuals who loose their health insurance due to a disability to continue coverage for 29 months.

Statistically, a person who is 35 years old and a member of the United States workforce has a 50 percent chance of disability for ninety days or more before he/she turns 65 years of age. Approximately twelve percent of the adult U.S. population suffers a long-term disability each year. Disability, therefore, materially impacts a significant portion of the American populace. Strikingly, approximately 85% of employees who become disabled are disabled because of disease rather than injuries.

A disability's financial impact can be devastating. The U.S. Social Security disability insurance program pays approximately $722 per month on average for permanently disabled workers, but according to Social Security Administration and Bureau of Labor statistics only approximately thirty-five percent of individuals that apply for such benefits actually qualify and receive benefits. Approximately 80% of Americans have little or no disability protection. Of those that do have private disability insurance, the typical program only pays 50-60% of the employee's previous income. Moreover, the disability insurance payments frequently are taxable as income, further reducing the net amount available to the employee.

When an employer terminates an employee, the employee, if he has been a participant in the employer-sponsored group health insurance plan, has the right to continue his group health insurance coverage under COBRA. (Hereinafter an employee who is a participant in an employer-sponsored group health insurance policy shall be referred to interchangeably as an “employee” or a “participant.”) However, the terminated participant typically must pay the entire premium (monthly payment) for his coverage under the group plan, including the substantial portion previously paid by the employer; the employer no longer pays a share of the health insurance costs for the terminated participant.

For example, if an participant's group health plan's cost for family coverage is $1,250.00 each month, while employed the participant may have paid $400.00 each month, and the employer would have paid the remaining $850.00. If the participant thereafter is terminated and is disabled, and if he qualifies under COBRA provisions or the equivalent state law provision (hereinafter referred to for ease of reference as “COBRA”) for health care benefits, he thereafter must pay the entire $1,250.00 himself. The participant also may be charged up to 2% more than the premiums to administer the plan, in which case the COBRA premium could be $1,275.00.

Thus, a terminated participant usually will pay much more for his group health plan with COBRA than he paid while employed. Even though COBRA represents a higher cost to the terminated participant, it still may be the best or only option since he is not typically eligible for any other health insurance with pre-existing condition limitations provisions.

But the problem—and it is a huge problem—is that, as a practical matter, most disabled ex-employees/participants cannot afford to pay the premiums for COBRA health insurance, even if they are receiving benefits from disability insurance. Even if the employer has provided disability insurance as part of the employee benefits package for it employees, because such disability insurance typically only pays 50-60% of the employee's wages, the participant now has a reduced income with which to pay all of the same expenses that he/she had before, and yet must pay the substantially increased COBRA health insurance cost. Even if the other spouse is working, frequently that spouse's income is lower because he/she has to take substantial time off from work in the first few months to provide extra care for the disabled spouse. As a result, less than 10% of terminated disabled participants continue COBRA coverage for the entire time it is available.

This can hold great danger for the participant and his family. If the disabled participant has further medical needs—which is quite likely for a disabled employee—and suffers further medical costs, he/she will not have a health insurance policy in place to cover those costs. It is the inventor's understanding that, under the Bankruptcy Abuse Prevention and Consumer Protection Act of 2005, debts related to health medical costs generally are now much more difficult to discharge in bankruptcy than they previously were. The participant and his family may have the same disastrous financial experience that this inventor had: mortgaging the equity of his house to pay the medical bills, and ultimately losing the house and car because of the inability to make the payments. The likelihood of this occurring is demonstrated by the fact that approximately 46% of foreclosures of conventional home mortgages are brought about by disability.

Under the Health Insurance Portability and Accountability Act or applicable state law (hereinafter together “HIPAA”), once an ex-employee's COBRA benefits end (after the statutorily-mandated period), if the participant has maintained his coverage throughout the period the health insurance carrier must enable him to convert the group insurance to an individual insurance policy with like benefits and provisions, and without any additional waiting periods or pre-existing conditions restrictions. Such a conversion option makes it easier for the ex-employee to obtain individual insurance because he/she does not have to prove insurability (which would entail getting medical exams and tests that rule out certain medical problems for which the insurance company does not want to be liable). This is often difficult for the participant who has suffered a disability because the very thing that caused the disability will be objectionable to the insurance company. Moreover, benefits under the individual policy often will be different from the group policy, and the individual policy may be more expensive. But of course, if the participant employee has not been able to maintain the COBRA coverage health insurance, he/she cannot take advantage of this option. The invention enables the participant to be in a position to take advantage of this HIPAA provision.

Strikingly, there also are substantial losses for certain types of employers, such as hospitals, from the ex-employees inability to pay for COBRA coverage health insurance. Hospitals frequently find that their ex-employees who are disabled return to the hospital for treatment. Those employees usually are not able to pay their bills. The hospital, therefore, finds that it must absorb the cost of the ex-employees' treatment. In one example with which the inventor is familiar, the hospital has approximately 15,000 employees, of which 400+ went out on disability in one recent year. Of those, approximately 390 were out at least 90 days on disability. Of those 390, approximately 280 were out on disability at least six months. At least 200 were out of work on disability at least a year. However, only six of the 400+ disabled employees kept their COBRA coverage health insurance. The hospital absorbed approximately millions of dollars of medical expenses for those disabled employees. The hospital experienced a loss of more than $5,000,000. This cost ultimately must be passed on to all other consumers of health care services provided by the hospital. The inventor estimates that the present invention would cost an estimated $1,700,000 before discounts, thereby saving the hospital more than $3,000,000.

Because of the recognition of the inability of most terminated employees to be able to pay for the COBRA coverage health insurance, many employers also feel a moral dilemma between retaining an employee on the employer's payroll when the employee cannot work effectively, thereby threatening the financial health of the employer, or terminating the disabled employee knowing that the employee probably will not be able to pay for continuing health insurance at a time when he/she is most likely to need it.

The present invention provides a method for rectifying these difficulties. At present there is no method similar to the present invention available to employers and/or participants.

Virtually the only type of insurance that does not have a disability waiver of premium is health insurance. Disability insurance has a waiver of premium provision. Life insurance can be bought up such that there is a disability waiver, and disability waiver premiums can be acquired for credit life insurance for such things as an automobile note or a mortgage. But the one insurance that a person cannot afford to lose, especially at a time of disability, is health insurance, and there presently does not exist any disability waiver of premium or other provision to cover inability to pay health insurance premiums because of disability.

One possible solution would be to provide group LTD, but there are some significant negatives and drawbacks with group LTD. First, the insurance carrier can cancel the insurance contract at any time. Second, the employer can cancel the contract at any time. Third, such additional insurance coverage is not convertible if one leaves the group. In contrast, the present invention provides for portability of the policy. Furthermore, neither the carrier nor the employer can cancel the contract.

### OBJECTS AND SUMMARY OF THE INVENTION

It is the object of the invention to overcome the above-noted shortcomings in the marketplace for group health insurance and to provide employers and employees with low-cost protection against the loss of their COBRA coverage health insurance benefits.

The method of the present invention is designed to overcome the above-noted shortcomings and fulfill the stated needs. The method provides for the making of substitute continuing periodic payments of premiums for an employer-sponsored group health insurance policy under COBRA during a period in which the participant is disabled and participating in said employer-sponsored group health insurance policy. The method comprises the steps of: (i) determining the amount of the total periodic premiums required to pay for continuing coverage of said employer-sponsored group health insurance policy if a participant becomes eligible under COBRA due to disability, taking into account elimination periods; (ii) purchasing, with funds paid periodically by the employer or the participant, or a combination of both, one or a plurality of disability insurance policies that will provide continuing substitute payment of the health insurance premiums during the eligibility period for COBRA coverage; and (iii) paying, upon the occurrence of a condition resulting in eligibility under the specifications of the disability insurance policy or policies, benefits from the disability insurance policy or policies to pay the total premiums for the eligible participant's COBRA coverage group health insurance.

In addition, the disability insurance policy(s) may also have an automatic increase feature, which will also provide for increases in the amount of the monthly benefit in case of increases in the COBRA premium, thereby further enhancing the disabled participant's ability to maintain his/her COBRA coverage.

It also may have a future insurability option (FIO) to preclude the participant from having to provide medical evidence of insurability in order to increase the existing monthly benefit of the health insurance policy as prices of healthcare increase.

The invention effectively replaces premium payments for the COBRA health insurance policy that the disabled participant otherwise cannot make. The invention effectively solves the problem of disabled participants losing their COBRA health insurance coverage at a time when they need it most. The invention further solves the moral dilemma for employers who recognize that the disabled participants will not be able to maintain their health insurance coverage if they are terminated. The invention also solves the substantial cost problems and losses for hospitals whose employees become disabled but still returned to the hospital for medical treatment for which the participants are not able to afford to pay.

For many employers, firing an employee who is sick or disabled presents a significant moral dilemma. The employer knows that the sick employee will lose his health insurance coverage because, even if he has disability insurance, the employee will not be able to afford health insurance under COBRA. One of the significant advantages of this method is that it removes that moral dilemma. By using this method, the employer can be assured that the employee will retain his health insurance coverage, while the employer need no longer pay the employee's salary, which would have been a substantial cost to the employer when the employee is no longer productive.

### BRIEF DESCRIPTION OF THE DRAWINGS

FIG. 1 is a flow diagram illustrating a method for providing a participant with insurance protection against the inability to pay for group health insurance benefits if an active participant becomes disabled.

FIG. 2 is a flow diagram illustrating a one embodiment of a method for providing a participant with insurance protection against the inability to pay for group health insurance benefits if an active participant becomes disabled.

### DETAILED DESCRIPTION OF THE INVENTION

The method provides for the making of substitute continuing periodic payments of premiums to the health insurance provider for an employer-sponsored group health insurance policy under COBRA during a period in which the participant is disabled. The method comprises the steps of: (i) determining the amount of the total periodic premiums required to pay for continuing coverage of said employer-sponsored group health insurance policy if a participant becomes eligible under COBRA due to disability, taking into account elimination periods; (ii) purchasing, with funds paid periodically by the employer or the participant, or a combination of both, one or a plurality of disability insurance policies that will provide continuing substitute payment of the health insurance premiums during the eligibility period for COBRA coverage; and (iii) paying, upon the occurrence of a condition resulting in eligibility under the specifications of the disability insurance policy or policies, benefits from the disability insurance policy or policies to pay the total premiums for the eligible participant's COBRA coverage group health insurance.

The amount of the premium for such an insurance policy or policies is strikingly small at present. For employers with more than 50 participants, if purchased on a group basis, the cost at 2006 rates would be approximately $25 per month per participant to provide the level of premium payments for COBRA coverage health insurance for the 40-year-old smoker participant addressed in the example above of a $1,250 per month health insurance premium. For employers with more than 100 participants, the cost typically would be even less.

Moreover, in one embodiment the actual out-of-pocket cost to the employer is substantially reduced because the employer pays the premiums but the employee pays the income taxes on the imputed income to the employee. In this embodiment, the cost of the premiums is deductible by the employer on its federal tax return. Because it is a disability premium, it is not subject to employer-payroll taxes. It is potentially a tax-deductible business expense to the employer. As a result, the total out-of-pocket after-tax cost to the employer is substantially less than the amount paid for the premiums. The cost to the employee of paying income tax is approximately five dollars per month if the premium is $25 per month and the employee is in a 20% tax bracket, and the net out-of-pocket after-tax cost to the employer is approximate $14 per month.

By using multi-life underwriting guidelines, this invention can take advantage of simplified and guaranteed issue-of-policy offers (regardless of pre-existing or current medical problems). Multi-life underwriting guidelines also provide for discounted premium rates (based upon the number of employees participating and source of premium).

In a preferred embodiment of the invention, the disability policies are issued individually and not under a group certificate, and therefore are portable so that the employee may take them with him if he changes employers.

In one embodiment of the invention, two or more disability insurance policies, which can be a short-term disability and a long-term disability policy or two equal-length policies, are coupled together and particular elimination and benefit periods are selected. This coupling of two policies is because many insurance companies do not offer disability policies that are precisely the length of time of the COBRA coverage period. The longer-term policy of the two disability insurance policies, or alternatively the second-in-time if the policies are of equal length, is portable. By joining two or more policies together, and by coordinating them with any existing short term disability or sick-pay plan, the invention maximizes cost control and savings for the users, and at the same time this method efficiently minimizes exposure to the employer and participant, as well as mitigates exposure to the insurance policy issuer(s).

The coupling of such types of disability insurance contracts provides coverage for the entire period of the COBRA coverage health insurance. In this embodiment, the employer is assumed to already have in place some form of sick-pay plan for their employees that will provide coverage for health insurance of 90 to 180 days after the employee becomes temporarily disabled. (Many employers, with 100 or more employees, have some form of a sick-pay plan in place for their employees; such plans generally provide disability or health coverage of 90 to 180 days.) Said embodiment of this invention, therefore, includes a short-term disability policy with a seven (7) to 365 day elimination period and a second disability insurance policy with an elimination period of between 90 and 365 days.

Short Term Disability (STD) insurance provides insurance protection against loss of income in the event the participating employee is unable to work due to accident or sickness. An STD contract is designed to pay a specified amount weekly, bi-weekly, or monthly for a period typically no longer than 24 months (2 years) after a brief waiting period (elimination period) ranging from 0 days for accidents and 7 days for sickness to as long as 6 months for both accident and sickness.

The long-term disability insurance policy (often called an Individual Disability Income (IDI) policy) also provides protection to cover expenses typically not considered in the event of a disabling injury or sickness. However, IDI policies typically provide benefits for a much longer period of time, ranging from a minimum of two years to age 65/67; some may pay lifetime benefits. While the cost of STD is typically age-banded (that is, insureds are grouped by age brackets), and may be increased when the employee crosses over into the next age group, premiums IDI contracts remain level. The elimination period used in IDI contracts are significantly longer as well, with the shortest being 30 days and the longest lasting as long as 2 years.

Said preferred embodiment also has a future insurability option (FIO) rider. This permits the participant to increase monthly benefits payable under the disability policy to keep pace with any increases of his group health insurance premiums. This option does not require evidence of insurability. Simply stated, as long as the participant is not currently receiving disability benefits from that policy, the monthly benefit amount can be increased by simply paying the additional premium necessary to pay for that additional benefit.

The preferred embodiment also contains an automatic increase provision allowing for increases in the monthly benefit to cover increases in the premiums for the COBRA coverage health insurance policy without requiring evidence of insurability. Without such a provision, it will be very difficult if not impossible for a participant to maintain the health insurance coverage because a disabled person would have substantial difficulty meeting the insurability requirements.

Another embodiment of this invention provides that the disability insurance policy or policies are guaranteed renewable. Said guaranteed renewable provision gives the participant the right to renew his disability policy or policies at the issued premium to a specified age (typically 65 or 67), as provided by the contract.

Another embodiment of this invention provides for the disability insurance policy or policies to be non-cancelable. Said non-cancelable provision provides that the only way the policy or policies can be canceled is if the participant fails to pay the required premium(s).

Another embodiment of this invention provides that the disability insurance policy or policies may have a return-of-premium rider. Said return-of-premium rider may allow the participant to recover a portion of the premiums paid for the disability insurance policy or policies over the life of the policy or policies as provided in the specifications policy(s).

In another embodiment of this invention, the disability insurance policy or policies have an unemployment waiver-of-premium rider. Said unemployment waiver-of-premium rider provides for premium payments if the participant becomes unemployed for a period of time specified in the specifications of the disability policy or policies.

In another embodiment of this invention, the disability insurance policy or policies have a military active-duty rider. If a participant is on active military duty or is called to active military duty, all benefits of the policy are placed on hold and all premiums due are waived during the time the participant is on active military duty.

In another embodiment of this invention, the disability insurance policy or policies have a tail-end waiver-of-premium rider. Said tail-end waiver-of-premium rider eliminates the need for premiums to be paid for the first 90 days following the participant's return to work after a disability.

Another embodiment of this invention provides for disability policy coverage beyond the period of COBRA coverage in the range of 90 days to thirty years. Said embodiment allows the participant to have greater security with respect to future health insurance coverage after the COBRA eligibility ends.

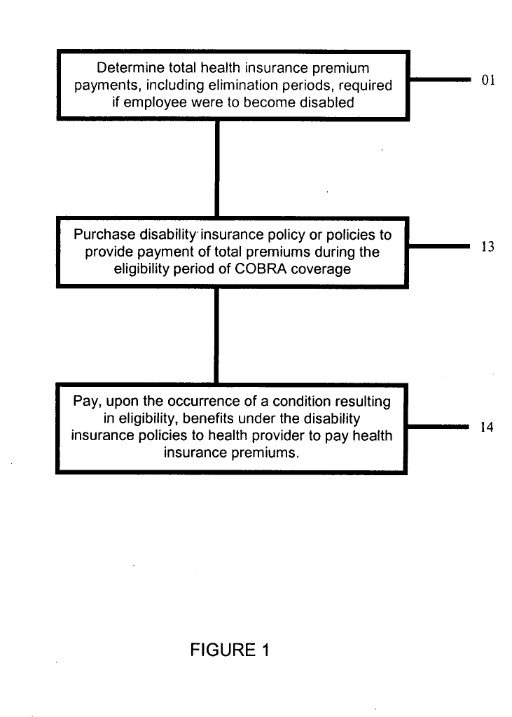

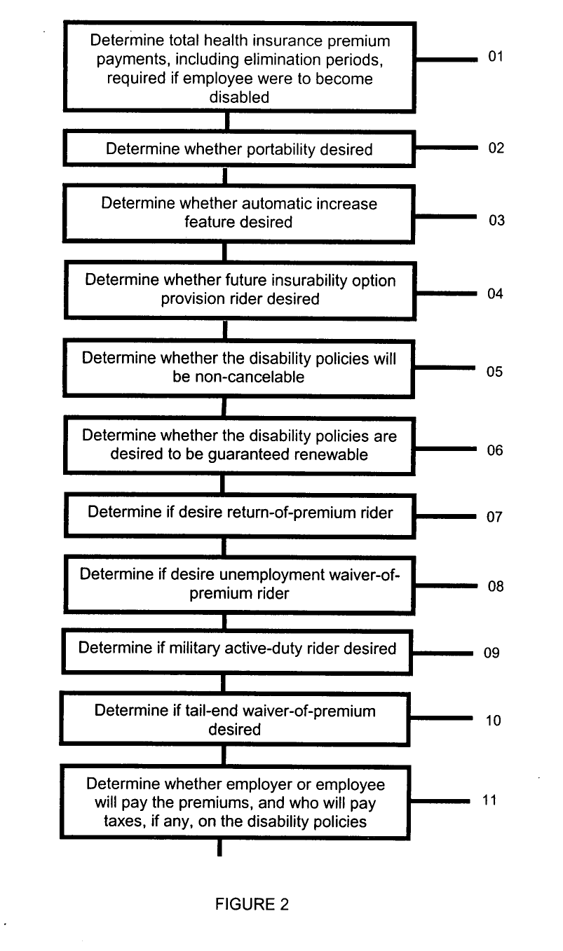

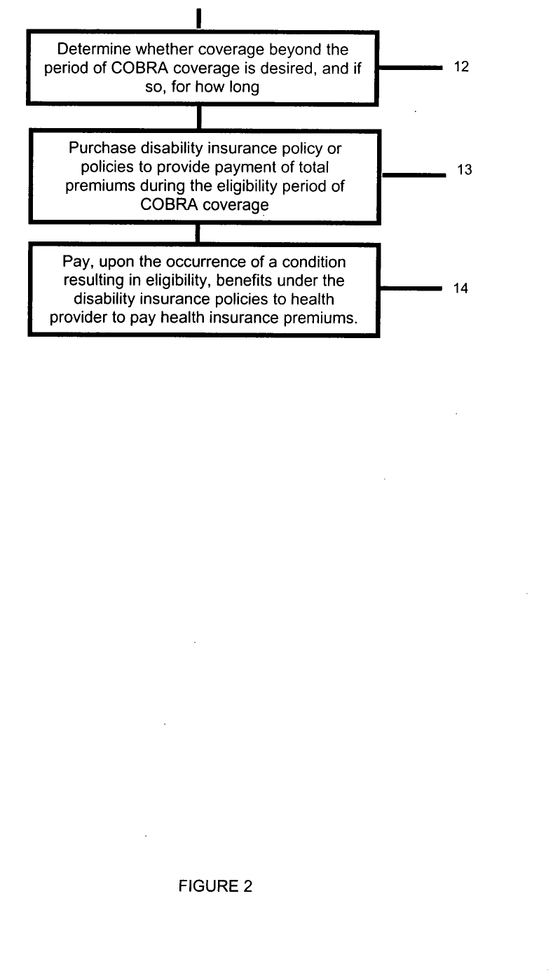

FIG. 1 is a flow diagram illustrating the three fundamental steps (01, 013-014) of the invention. FIG. 2 is a flow diagram illustrating the decisions, (002-012), made for an embodiment in which the riders addressed above are selected to provide the participant with a preferred embodiment of the invention.

I claim:

1. A method for the making of substitute continuing periodic payments of premiums for an employer-sponsored group health insurance policy under COBRA during a period in which the participant is disabled, comprising:
determining the amount of total periodic premiums required to pay for continuing coverage of said employer-sponsored group health insurance policy if a participant becomes eligible under COBRA due to disability, taking into account elimination periods;
purchasing with funds paid periodically by the employer or the participant, or a combination of both, one or a plurality of disability insurance policies that will provide continuing substitute payment of the health insurance premiums during the eligibility period of COBRA coverage;
paying, upon the occurrence of a condition resulting in eligibility under the specifications of the disability insurance policy or policies, benefits from the disability insurance policy or policies to pay the total premiums for the eligible participant's COBRA coverage group health insurance.

2. The method of claim 1 wherein the disability insurance policy or policies are portable.

3. The method of claims 1 or 2 wherein the disability insurance policy or policies have an automatic increase feature that will provide for increased payments from the disability policies to cover increases in the amount of the monthly premium for the health insurance policy.

4. The method of claims 1 or 2 wherein the disability insurance policy or policies have a future insurability option rider.

5. The method of claims 1 or 2 wherein the disability insurance policies comprises of a disability insurance policy with an elimination period in range of 0 days to 365 days and benefit periods in a range of from 1 month to 24 months coupled with a second disability insurance policy to cover the remainder of the total length of time that periodic payments must be made to make all premium payments for the health insurance during the period of time of COBRA coverage group health insurance eligibility.

6. The method of claims 1 or 2 wherein the disability insurance policy or policies are guaranteed renewable.

7. The method of claims 1 or 2 wherein the disability insurance policy or policies are non-cancelable.

8. The method of claims 1 or 2 wherein the disability insurance policy or policies have a military active-duty rider.

9. The method of claims 1 or 2 wherein the disability insurance policy or policies have a tail-end waiver-of-premium rider.

10. The method of claims 1 or 2 wherein the disability insurance policy or policies have a return-of-premium rider.

11. The method of claims 1 or 2 wherein the disability insurance policy or policies have an unemployment waiver-of-premium rider.

12. The method of claims 1 or 2 wherein the employer pays the premiums, and the employee pays income taxes on the imputed income.

13. The method of claims 1 or 2 wherein the disability policy provides coverage beyond the period of COBRA coverage for up to ten (10) years.
